(19) United States
(12) Patent Application Publication
(10) Pub. No.: US 2003/0093380 A1
(43) Pub. Date: May 15, 2003

(54) Methods and systems for encrypting and correlating data

(76) Inventor: Arash Esmailzadeh, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/992,867

(22) Filed: Nov. 14, 2001

(51) Int. Cl. G06F 17/60

(52) U.S. Cl. 705/50

(57) ABSTRACT

The present invention provides methods and systems by which data is encrypted securely, stored within a host server, and retrieved upon request from a client system. In one embodiment, a first user, such as an architect, enters information including manufacturer model part numbers. A request is then sent to the host server to encode the manufacturer's model part numbers. The host server encodes and saves the encoded model part numbers in a project information database. A second user, such as a manufacturer, retrieves the project information by entering the encoded model part numbers and requesting the host server to decode the encoded part numbers. The host server then maps the encoded part numbers to the manufacturer part numbers and transmits the project information to the manufacturer.

### BACKGROUND OF THE INVENTION

1. Field of the Invention

The present invention is related to data processing and in particular to methods and systems for encoding and correlating information.

2. Description of the Related Art

Conventionally, when designing a building or other structure, an owner or developer hires an architect. The architect plans a project, selects appropriate part numbers for such items as lighting fixtures, sinks, doorknobs, or other fixtures and parts, and lists the part numbers on an architectural plan. Planning the project includes drafting architectural drawings and selecting model part numbers for building materials to be used on the project. Once complete, the plan is submitted to the owner for approval. At this time, the owner will have an opportunity to approve the architectural plans, specifically the drawings and the types of building materials being used, represented by the model part numbers, and an estimated cost. A budget for the project is then set.

Several contractors are typically chosen to bid on the project. The contractors are given time to review the plans generated by the architect. Once the contractor bids are submitted, the owner then decides which contractor to award the project to. The decision usually depends on a price submitted by the contractor, and may also depend on the quality of previous work performed by the contractor for the owner, on recommendations by other owners, or the like.

Once the owner awards the project to a contractor, the construction project may begin. The contractor may search for a least expensive parts distributor who can supply the parts in a timely manner and maximize the contractor's profit margin. Using conventional methods, many contractors have accepted a project with previously set guidelines of specified model part numbers, but were able to find alternate building materials at a lower price. Therefore, without prior approval of the owner or architect, the contractor would substitute a part number itemized in an original architectural plan with a less expensive item. In essence, the contractor would increase his profit by using less expensive, and often lower quality materials, while the owner believes she is receiving the items specified in the architectural plans submitted to the contractor.

The process continues with a parts distributor ordering the building materials specified by the contractor, including parts unauthorized by the architect or owner, from a manufacturer sales representative.

If initial contractor bids are too high, the project may undergo a rebidding process to better ensure that the projects meets the project budget.

The resulting project is often unsatisfactory from the perspective of the architect and the owner due to the substitution of unauthorized, often inferior parts.

### SUMMARY OF THE INVENTION

The present invention is directed to methods and systems for ordering building materials using encrypted or encoded model part numbers. A novel parts management system is utilized to create, store and retrieve encoded model part numbers for the purpose of better managing the specification procurement process of building materials for a given project. Manufacturer model part numbers are ordered for building materials, such as sinks, pipes, doorknobs, light fixtures, faucets, light switches, and the like. By utilizing encoded model part numbers, where an architect, developer, owner, or authorized representative of the owner (hereinafter simply referred to as “the owner”) and a manufacturer, have access to actual manufacturer or decoded model part numbers while the contractor is provided only with encoded part numbers, a contractor is forced to procure the building materials as specified in an architectural plan. In this manner, the contractor is not given an opportunity to substitute less expensive, lower quality materials.

In one embodiment of the present invention, the architect, owner or other parts specifier enters the project information using the parts management system. The project information may include a project number, name, and address, an architect's name, phone number, and address, a manufacturer's sales representative's name, phone number, and address, and general notes. In addition, the parts specifier inputs into appropriate form fields manufacturers' names, and manufacturer model part numbers, as well as the quantity, type, and a brief part description corresponding to each of the manufacturer model part numbers. The “Type” information is used to indicate, for example, what room of a building the part is to be used in. The brief description can include a generic description of the part. For example, for a lighting fixture the brief description may state that the part is a “low voltage exterior lighting fixture.” The parts management system returns corresponding encoded or encrypted part numbers to the architect. The project information, including the manufacturer part numbers, and corresponding encoded part numbers are stored in a parts management system database and/or on a client system associated with the architect. The architect then lists the encrypted part numbers on the architectural plans. The architectural plans are then provided to the contractor for bidding on the project or for ordering parts. Optionally, the manufacturer's identity, but not the actual part number, is provided to the contractor.

When a project has been awarded to the contractor, the contractor orders from a parts distributor the building materials or parts using the encrypted part numbers and, optionally, manufacturer's identity. The parts distributor contacts the manufacturer and provides the encrypted part numbers and related information, such as quantity and type. The manufacturer then accesses the manufacturer model part numbers from the parts management system by entering the project number and/or the encoded model part numbers. The parts management system uses the encoded model part numbers to retrieve the corresponding manufacturer model part numbers from the parts management system database. The retrieved manufacturer model part numbers are then provided to the manufacturer. Once the manufacturer has retrieved the manufacturer model part numbers, the corresponding costs are provided to the parts distributor who then provides the information to the contractor.

In another embodiment, the contractor accesses the parts management system and enters the project identification number and/or the encoded model part numbers through a web browser or other access device. The parts management system then returns a list of manufacturers' and/or their representative's names and phone numbers, in association with the corresponding encoded model part numbers, to the contractor to contact for pricing information. The parts management system, simultaneously, sends an electronic message, for example, to the manufacturer relaying the contractor's name, phone number, and/or address, the encoded model part numbers, and the decoded manufacturer model part numbers for future transactions. Optionally, the electronic message is sent to the manufacturer without the decoded manufacturer model numbers. As a result, the manufacturer receives the encoded model part numbers and in turn requests the host server to decode the encoded model part numbers. Messages containing the contractor's information and encoded model part numbers can optionally be sent to the manufacturer by mail, UPS, or the like. Alternatively, the parts management system looks up price information for the parts stored on a parts management system price list database, and transmits an encoded parts list with the associated prices to the parts distributor and/or manufacturer. The contractor can then contact the manufacturer(s) or parts distributor(s) for pricing information by providing the manufacturer with the project number and/or the corresponding encoded model part numbers.

If the pricing is satisfactory and the budget is met, the contractor can then order the building materials and have the parts delivered or shipped. If the budget is not met, the project may go up for bidding again. The architect will select new, lower cost manufacturer part numbers. The process discussed above, including encoding model part numbers, awarding the project to a contractor, locating a parts distributor, and ordering from a manufacturer will be repeated.

The architect, owner, and/or authorized representative can then access the new project information for viewing or editing purposes.

### BRIEF DESCRIPTION OF THE DRAWINGS

FIGS. 1A-1B illustrate a high level architectural view of an example parts management system and a record structure for use therewith;

FIGS. 2A-2B illustrate an example process of entering project information by an architect and obtaining encoded part numbers;

FIG. 3 illustrates an example process of a manufacturer retrieving manufacturer model part numbers and project descriptions;

FIG. 4 illustrates an example first client application form intended to be utilized by an architect, owner, authorized representative;

FIG. 5 illustrates an example second client application form intended to be utilized by a manufacturer; and

FIG. 6 illustrates an example bidding and awarding process for a new project.

### DETAILED DESCRIPTION OF THE PREFERRED EMBODIMENTS

The present invention is directed to systems and methods for ordering building materials, and in particular to novel methods and systems for ensuring the integrity of the materials acquisition process. Building materials include items such as sinks, pipes, doorknobs, light fixtures, faucets, light switches, and the like. Advantageously, a parts management system utilizing a part number encoding process, in accordance with the present invention, overcomes the deficiencies of conventional methods of ordering parts and ensures that an owner or a developer receives the authorized parts specified in an architectural plan.

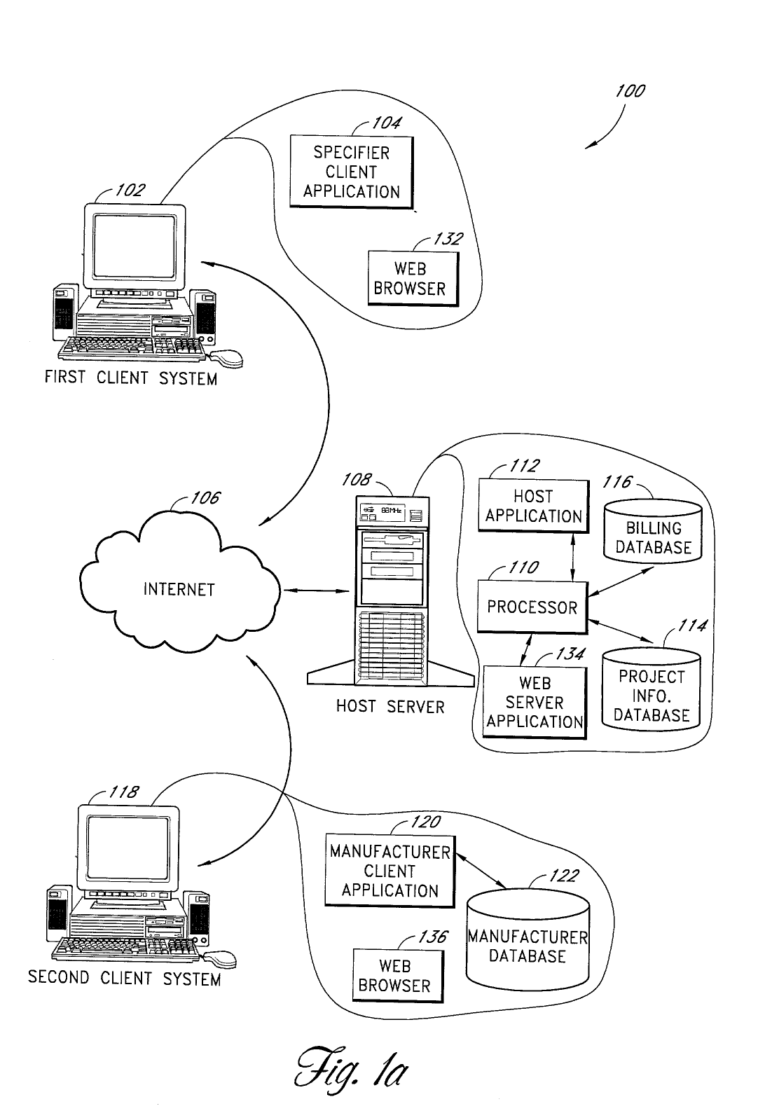

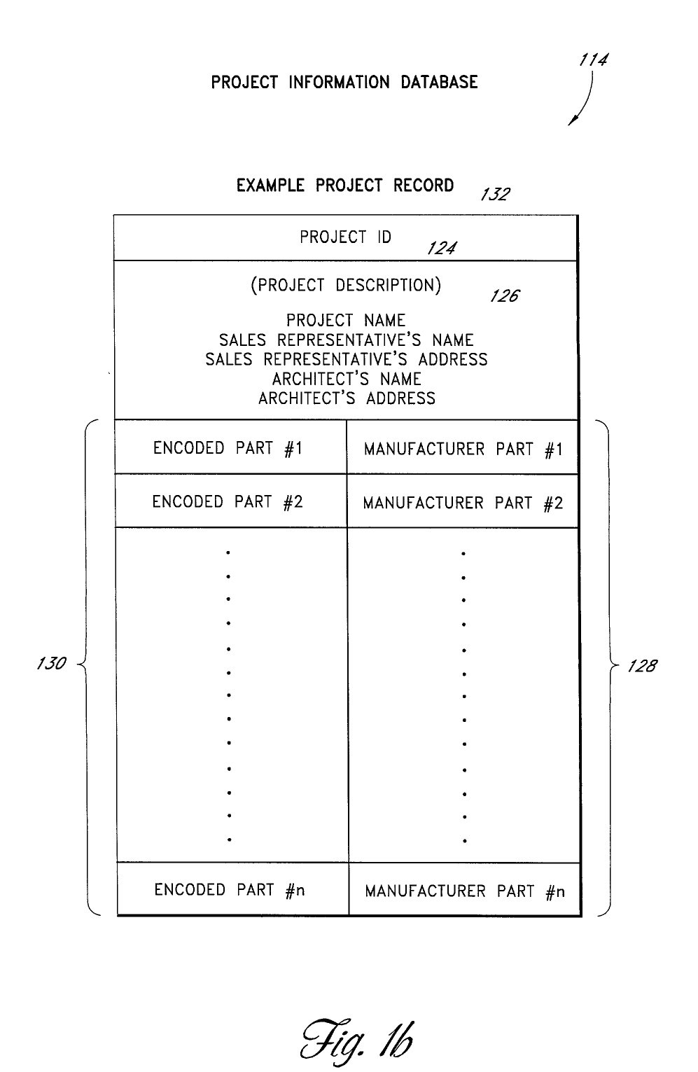

FIG. 1A illustrates an example architecture of a parts management system in accordance with one embodiment of the present invention. The parts management system 100 includes a host server 108 containing one or more processors 110, a host parts management application 112, a project information database 114, a billing database 116, and a web server application 134. The parts management system 100 also includes a first client system 102, which contains a specifier client application 104 and a web browser 132. A second client system 118 contains a manufacturer parts management client application 120, a manufacturer database 122, and a web browser 136. The first and the second client systems 102 and 118 may communicate with the host server 108 through a network 106, such as the Internet in one embodiment of the present invention. Other embodiments may include communication networks such as an intranet, LAN/WAN systems, dial-up networks, wireless systems, or the like.

The specifier client application 104 provides a user interface which allows the architect to enter new project information and manufacturer model part numbers, which are then encoded by the host parts management application 112 as described below. The specifier client application 104 is also utilized to locate and retrieve current and past project records previously submitted to the host server 108. The specifier client application 104 optionally, saves project records on storage media, such as a hard drive, a floppy disk, a writable CD, or the like.

The manufacturer client application 120 provides a second user interface that allows the manufacturer to decode the encoded model part numbers and retrieve project information. The manufacturer database 122 includes part record files. The part record files include part numbers, part costs, amount in inventory, and the like.

The client applications 104 and 120 are initially downloaded over the network 106 from the host server 108 to the first and second client systems 102 and 118, or are installed from a CD-ROM or a floppy disk.

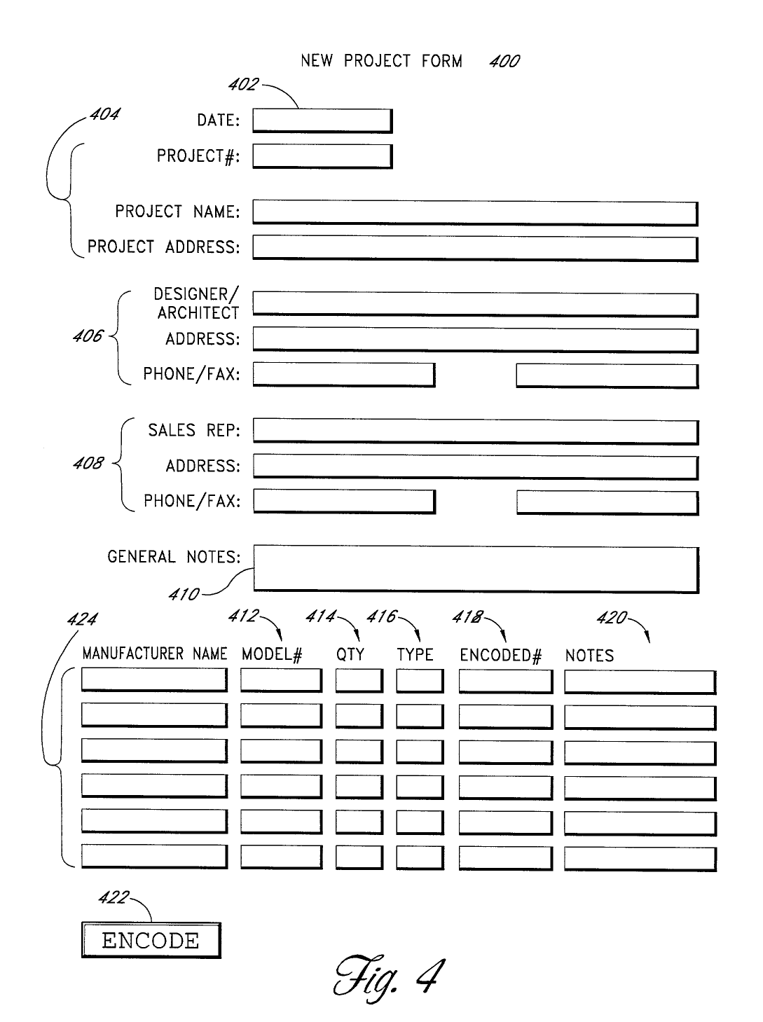

Optionally, rather than having a client specifier application 104 and a client parts management application 110, the entire system is hosted on the host server 108 and web pages are served using the web server application 134 and accessed via browsers, 132 and 136. Thus, for example, the architect can access the project form illustrated in FIG. 4 as a web page via the Internet. Similarly, the architect can access the manufacturer retrieval form as a web page via the Internet.

FIG. 1B further illustrates the project information database 114. The project information database contains a plurality of project records 132. Each project record 132 includes a project identification number 124, a project description 126, manufacturer model part numbers 128, and corresponding encoded part numbers 130. The project description 126, by way of example, includes a project name, a sales representative's name and address, and an architect's name and address.

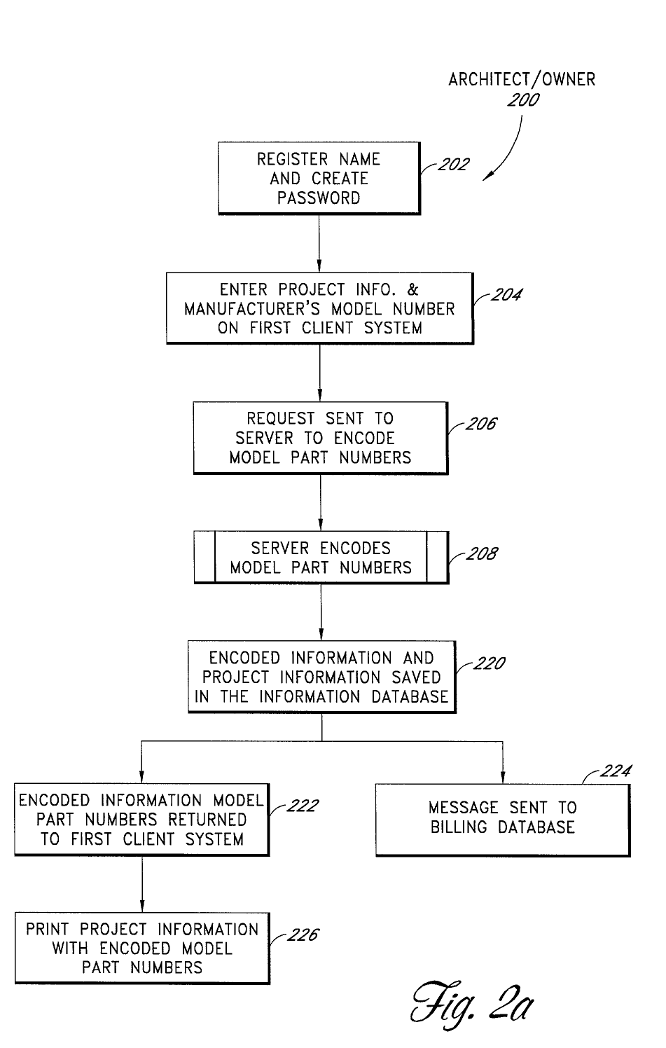

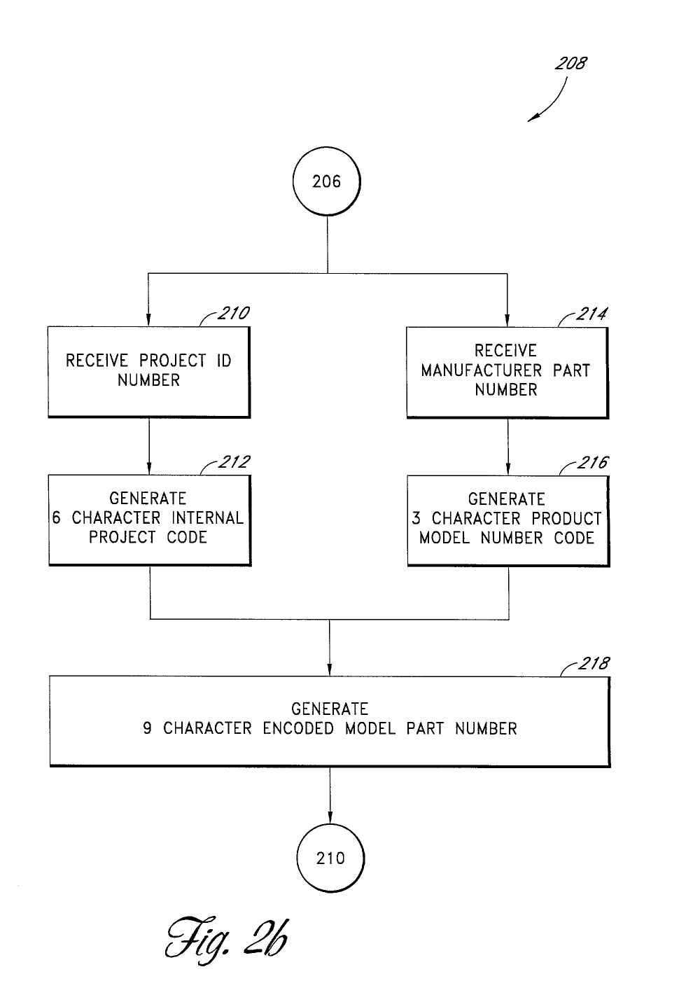

FIGS. 2A-2B illustrate an example process 200 of utilizing the parts management system 100 by the architect or other authorized parts specifier to enter project information and manufacturer part numbers for encoding and storage. If the architect has not previously registered, then the architect accesses the parts management system website hosted on the host server 108 via the first client system 100. The architect, at state 202, registers his name, selecting a user ID and creating a first password. If the architect has previously registered, then the architect enters his user ID and the first password to gain access to existing project records, register a new project, or enter new project information within the parts management system. Alternatively, project information can be entered offline, utilizing the specifier client application 104.

As part of the process, the architect or other user may be requested to provide billing information, such as a credit card number, a debit card number, and/or a billing address. In one embodiment, the architect may be billed for usage of the parts management system on a monthly basis or per project basis. In another embodiment, the owner, developer, or manufacturer is responsible for fees incurred by the architect's, owner's, or manufacturer's usage of the parts management system. Billing may be based on having a parts order placed, each new project entered, edits to a current project, and/or a basic periodic fee.

Once registration is complete, a second password is created for the owner or the owner's authorized representative. The second password may be created by the architect or automatically by the parts management system 100. The owner or authorized representative, using the second password is, in one embodiment, restricted to viewing the project information, including the specified part numbers, thereby preventing the owner or authorized representative from modifying the parts list without the architects approval. Optionally, however, the owner or authorized representative can also be allowed to edit project information. The second password is transmitted electronically or sent by mail to the owner. Thus, the architect uses the first password to access the project record, then enter or edit information, such as the manufacturer model part numbers. The owner or authorized representative can access and view the project record stored on the host server 108 by accessing the project information database 114 by entering the second password. Optionally, the first password can be stored on the first client system 102 by way of a cookie or the like, so the architect does not have to re-enter the password each time the architect accesses the project record. Similarly, the second password can also be stored on the owner's client system (not shown).

Once the passwords are designated, the architect then enters the project information at state 204 via the specifier client application 104 or via the browser 132. The project information may include a project name and number, a sales representative name and address, the architect name and address, and the manufacturer model part numbers. The architect may enter this information into a new project form provided by the specifier client application 104, an example of which is illustrated in FIG. 4. The project form may alternatively be served by the host server 108 and accessed via the web browser 132.

Once the information has been entered, the architect sends a request to the host server 108 to encode the manufacturer model part numbers at state 206. In one embodiment of the present invention, if the architect is entering information electronically, while online, the architect makes a request to encode the model part numbers directly to the host server 108 at state 206. The host server 108 then receives the request and encodes the manufacturer part numbers and saves the project record to the project information database 114, at state 208. Optionally, the project record can also be stored on the first client system 102 by the architect, owner, or owner's authorized representative.

FIG. 2B illustrates the encoding process at state 208 in greater detail. To encode the manufacturer part numbers, in one embodiment, the host server 108 generates the project identification number at state 210 and pseudo randomly generates a 6 alphanumeric character project code at state 212. In another embodiment, the architect can provide the host server with a project identification number. The host server 108 receives the manufacturer part number at state 214 and, using the project identification number, pseudo randomly generates a 3 alphanumeric character product model number code at state 216. The 6 character project code and the 3 character product model number code are then combined to create a 9 character encoded model part number at state 218. Optionally, the 9 character encoded model part number 218 may be further encoded. For example, if a project identification number, “PJ1001” and manufacturer part number “S03”, are entered, the host server 108 may encode the project code as “AFW183” and the product model number code as “D78”. The project code and the product model number code are then combined to form “AFW183D78”, in one embodiment. Of course different length encoded model part numbers and project codes can be used as well.

Other forms of encryption or encoding can be utilized. For example, public/private key cryptography may be used. If public/private key cryptography is utilized, then a public and private key is generated at the first client computer system 102 or at the host server 108. Upon a request by the first client computer system 102, the public key is transmitted to the host server 108 to encode the manufacturer part number, while the private key remains on the first client computer system 102. The private key is then used when decoding the encoded part numbers. A second private key is generated at the first client computer system 102 and sent to the manufacturer electronically via email, by mail, or the like. The manufacturer can then use the second private key to access and decode the encoded part numbers.

Still another alternative method of encoding will now be described. Rather then encoding or encrypting a manufacturer part number based on the characters or numbers in the part number, for each manufacturer part number an index or pointer to a part number look-up table or database is generated. This index or pointer then acts as the encoded part number. For example, if Manufacturer X has an assigned manufacturer identifier, and has a further assigned project identifier, then the first part number associated with the manufacturer entered for the project will be encoded as:

manufacturer identifier+manufacturer project identifier+sequential number

Thus, for example, if the manufacturer identifier is 8H7, and the manufacturer project identifier is 2DDDDD, and the part number being encoded is the first one listed by the architect from the manufacturer, then the encoded part number/index is 8H7-2DDDDD-A1. The next listed part number for that manufacturer is encoded as 8H7-2DDDDD-A2, and so on.

Optionally, only part numbers of manufacturers registered with the parts management system are encoded. If the part number is not that of a registered manufacturer, then the part number is not encoded, and the original manufacturer part number will be listed on parts lists generated by the parts management system. This encourages manufacturers to register with the parts management system to ensure that their part number are encoded, thereby preventing orders being diverted by the contractor to other manufacturers.

At state 220, the host server 108 saves the project record in the project information database 114. The host server 108 also returns each 9 character encoded model part number 218 to the specifier client application at state 222. Once the encoded part numbers are generated, returned, and displayed on the client computer system, the architect may store the information in a file on the client computer system 102 for later access and/or may print a hardcopy to forward on the owner and/or a contractor at state 226. Optionally, the parts management system can export the project record, including the encoded model part numbers and corresponding manufacturers' names, to an architectural planning software, such as computer aided design (CAD) tool application programs. The architectural planning software can then include the encoded model part numbers and manufacturers' names on the architectural plans or on related documents.

Substantially simultaneously, the billing database 116 receives and stores billing information regarding the usage of the parts management system by the architect and/or owner at state 224. Billing information may include at least the project identification number, the date and/or time when the architect entered the information, a date of when a bill is to be or has been sent out, a date of when payment is received, and a fee amount. In one embodiment, only manufactures are billed for use of the parts management system. In another embodiment, the architect or owner is billed for use of the parts management system.

Optionally, rather than provide the project information over a network, the architect saves the information on a floppy disk or other writable media via the first client computer system 102. The architect then sends the floppy disk or other writable media to a parts management system operator. The parts management system operator extracts the stored project information from the storage media, encodes the manufacturer part numbers, and returns the encoded part numbers using the parts management system to the architect electronically over a network, on storage media, or in hardcopy form. The architect then attaches a hardcopy or electronic copy of the encoded part numbers to the architectural plans.

Once the architectural plans are ready, a plurality of contractors is chosen by the owner to bid for the project. Once the contractor bids are received, the owner then chooses one contractor to build or manage the project. The chosen contractor is given the architectural plans and locates a parts distributor. The contractor selects several parts distributors to bid for the project. The chosen parts distributor is then given the encoded parts list from the architectural plans. The chosen parts distributor takes the parts list to a manufacturer to purchase the building materials specified on the architectural plans, listed by encoded model part numbers.

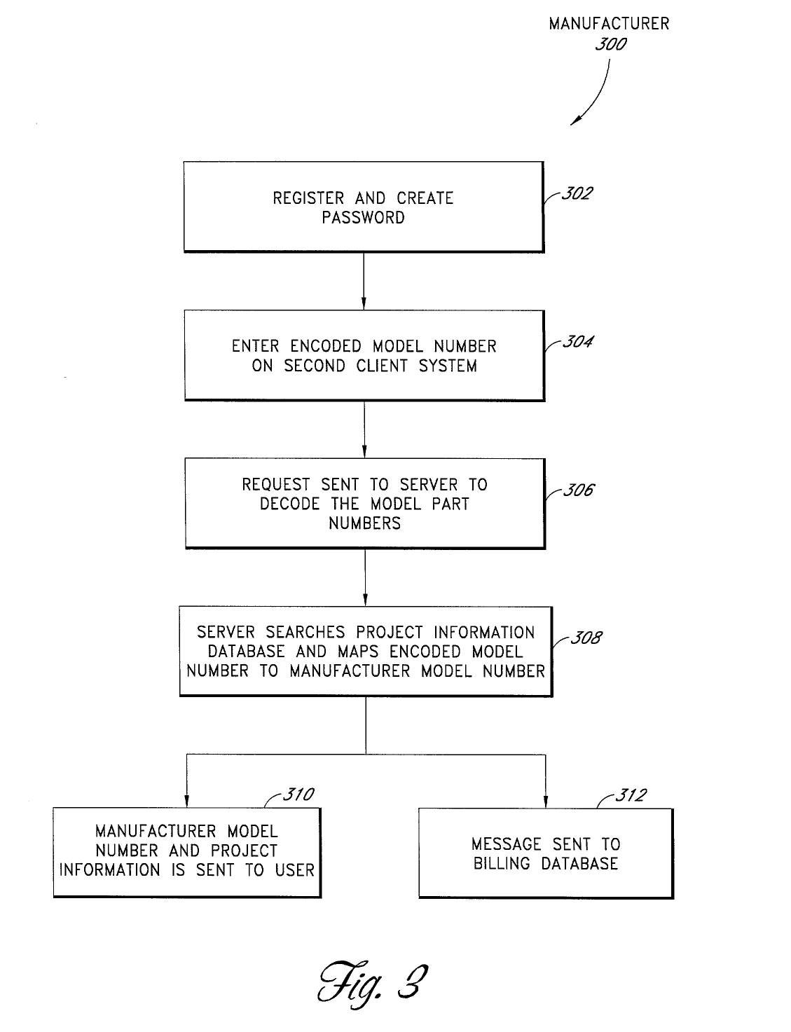

The manufacturer can decode the encoded model part numbers, that is, retrieve the manufacturer part numbers and the project description by utilizing the parts management system 100. The project information, which includes the manufacturer model part numbers, can be retrieved from the host server 108 via a network, floppy disk, or CD-ROM. FIG. 3 illustrates an example process 300 of retrieving project information by the manufacturer.

The manufacturer initially registers the manufacturer's name and contact information and creates a third password at state 302. Optionally, the password may be created for the manufacturer and stored in a cookie on the second client system 118. The password is accessed each time the manufacturer attempts to retrieve the project information. The manufacturer also has an option to change the third password. Optionally, the manufacturer only needs one password to access information for all projects on which it is a designated supplier.

The registration process also includes entering billing information, such as a credit card number, a debit card number, or a billing address. In one embodiment, the manufacturer may be billed for usage of the parts management system on a monthly basis or a per project basis. Billing may be based on each project viewed, each encoded model part number that is decoded, and/or a basic periodic fee.

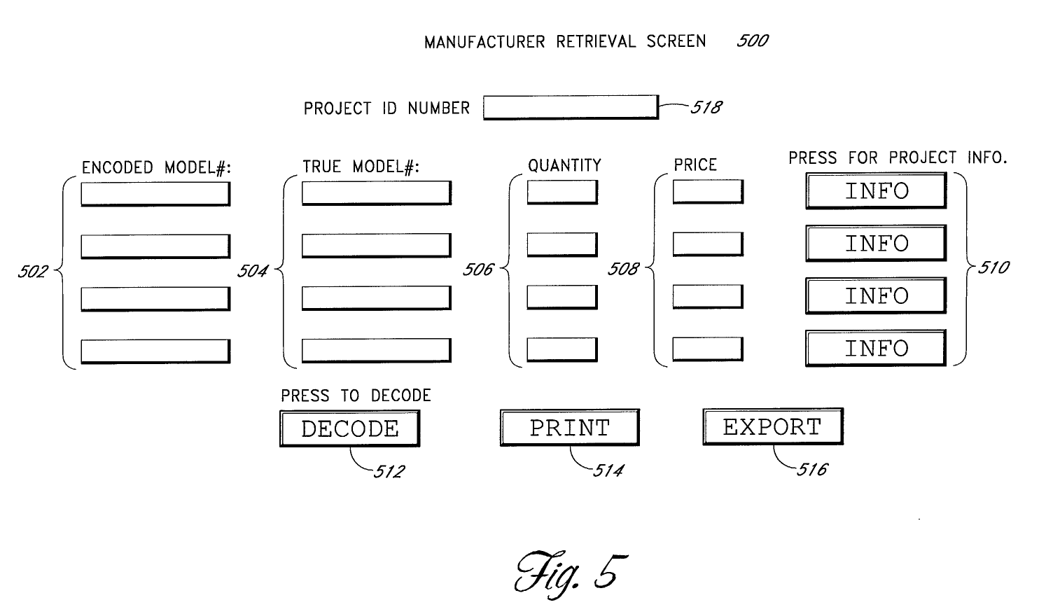

Once the manufacturer enters the password, at state 304, the manufacturer then provides the encoded model numbers listed on the architectural plans. The manufacturer may enter the encoded part numbers in the manufacturer retrieval form depicted in FIG. 5 presented by the manufacturer client application 120 or accessed via the web browser 136. This information can optionally be entered while the manufacturer is online, that is, in networked communication with the host server 108, or while offline. At state 306, if the manufacturer is accessing the parts management system online, then a message is sent to the host server 108 to decode the model numbers online. If the manufacturer is entering the encoded model part numbers while offline, the manufacturer can save the information locally on a hard drive, floppy disk, or writable CD for later use. The manufacturer can later retrieve the information stored locally and electronically transmit the encoded model part numbers to the host server 108 for decoding. Optionally, the manufacturer can retrieve the encoded model part numbers stored locally earlier and send the encoded model part numbers on physical storage media by mail, UPS, or the like. In addition, the manufacturer can request to receive the project information from the parts management system operator on physical storage media, such as a floppy disk or CD-ROM, or in hardcopy form by mail, UPS, or the like.

If the manufacturer is retrieving the project information online, then once the parts management system host server 108 is contacted, the host server 108 searches the project information database at state 308 for a match between the encoded model part numbers and the manufacturer model part numbers. Once the search is complete and the requested model part numbers are located, the host server 108 transmits the information back to the manufacturer at state 310, and is displayed on the manufacturer client application 120 or the web browser 136. If a match cannot be found, due to a data entry error or the like, a “Not Found” indicator is displayed in conjunction with the corresponding encoded model part number.

In one embodiment, rather than having to provide the encoded part numbers to the parts management system, the manufacturer provides the manufacturer identifier and the manufacturer project identifier. The manufacturer identifier and the manufacturer project identifier can be generated by the client application and provided to the architect, who in turn provides it to the contractor. The contractor in turn provides this information to the parts distributor or manufacturer who provides it to the parts management system. The parts management system uses this information to locate all of the manufacturer's part numbers listed for the project.

Simultaneously, the billing database 116 receives and stores billing information regarding the usage of the parts management system by the manufacturer at state 312. Billing information may include at least the project identification number, a date of information retrieval by the manufacturer, a date of when a bill is sent out to the manufacturer, a date of when payment is received, and a fee amount. A parts management system operator may enter additional billing information, such as notes and pricing information through the host application 112.

Once the parts are ordered, they delivered with an invoice to the contractor or the building site. The invoice lists both the encoded part numbers and the actual part numbers corresponding to the part numbers listed corresponding in UL (Underwriters Laboratories) or ETL Testing Laboratories testing. This allows the contractor to ensure that the ordered parts were delivered while providing the actual part numbers needed for approval by city inspectors and to comply with building codes.

In another embodiment, the contractor utilizes the parts management system to enter a project identification number and/or encoded model part numbers through a web browser on a third client computer system. Initially, however, the contractor registers his name, phone number, address, and license number on the parts management system. Once registration is complete, a fourth password is created automatically by the parts management system for the contractor or the contractor may create his own password.

The contractor then enters the project identification number or the encoded model part numbers. The host server 108 is contacted and returns a list of each manufacturer's name and phone number in association with the corresponding encoded part numbers manufactured or supplied by the manufacturer. This list is given to the contractor to contact the manufacturers for pricing information. The parts management system, simultaneously, sends an electronic message to the manufacturer relating the contractor's name, phone number, and/or address and encoded model part numbers for future transactions. Messages containing the contractor's information and encoded model part numbers can optionally be sent to the manufacturer by mail, UPS, or the like. The contractor can then contact the manufacturer(s) for pricing information.

FIG. 4 illustrates a sample project form 400 containing a date field 402, project number, name, and address fields 404, architect's name, address, and phone number/fax fields 406, sales representative's name, address, phone number/fax fields 408, a general notes field 410, manufacturer model number fields 412, quantity fields 414, type fields 416, encoded number fields 418, notes field 420, an encode button 422, and manufacturer name fields 424. The project form can optionally include a “brief description”field. The brief description can include a generic description of the part. For example, for a lighting fixture the brief description may state that the part is a “low voltage exterior lighting fixture.” Once the architect enters the manufacturer model part numbers in the model number field 412, the quantity desired in the quantity field 414, the type, indicating in which room or location the part is to be used, in the type field 416, any applicable notes in the notes field 420, the architect presses or selects the encode button 422. The architect may optionally enter the manufacturers' names in the manufacturer name fields 424 for added information. Alternatively, the architect can select the manufacturers name from a drop-down list of names. If the architect is utilizing the parts management system online, then the host server 108 is contacted and the manufacturer model part numbers are encoded, saved on the project information database, and returned back to the architect. The encoded model part numbers are then displayed in the encoded number fields 418. The form information is stored in a corresponding database.

In another embodiment, rather then using the same form to enter project information and part information, a separate form can be used to enter the project information. In addition, a separate form or forms can be used to enter part information for each manufacturer.

A parts list can be printed out for use by the contractor based on the information in the form 400. The parts list can include, for example, the architect's name, address, and phone number/fax information, sales representative's name, address, phone number/fax fields 408, the information entered into the a general notes field 410, quantity fields 414, type fields 416, encoded number fields 418, notes field 420, manufacturer name fields 424, and into the brief description fields.

FIG. 5 illustrates a sample manufacturer retrieval form 500 that the manufacturer can utilize to retrieve a project record. The manufacturer retrieval form contains encoded model number fields 502, manufacturer model number fields 504, quantity buttons 506, price buttons 508, information buttons 510, a decode button 512, a print button 514, an export button 516, and a project identification number field 518. The manufacturer enters an encoded model part number corresponding to a part manufactured or available from the manufacturer into a corresponding encoded model number field 502. Once the manufacturer has entered the encoded part numbers, the manufacturer presses or selects the decode button 512 to retrieve the corresponding manufacturer model part numbers. Optionally, the manufacturer enters a project identification number and selects the decode button 512 to retrieve all corresponding manufacturer model part numbers specified for this particular project. If the manufacturer is utilizing the parts management system online, then by pressing or selecting the decode button 512, the host server 108 is contacted. For each encoded model part number, the host server 108 then searches for the corresponding manufacturer model part numbers. Once located, the manufacturer model part numbers are transmitted back to the manufacturer and displayed in the manufacturer model number fields 504 or via a report. Optionally, the manufacturer can press or select the information button 510 to retrieve additional project information including a project description and model part number quantity, type, and notes.

Once the corresponding manufacturer model part numbers are retrieved, the price of each item may be provided in the price field 508 for generation of a quote. The quantity field 506 can be populated automatically when the project information is retrieved, by selecting the information button 510. Optionally, the quantity can be manually entered. The manufacturer can then save the encoded model part number, the manufacturer model part number, and the project description on storage media, such as a hard drive, a floppy disk, writable CD, or the like by pressing or selecting the export button 516. The exported manufacturer model part numbers and related project information are then used to generate a price quote.

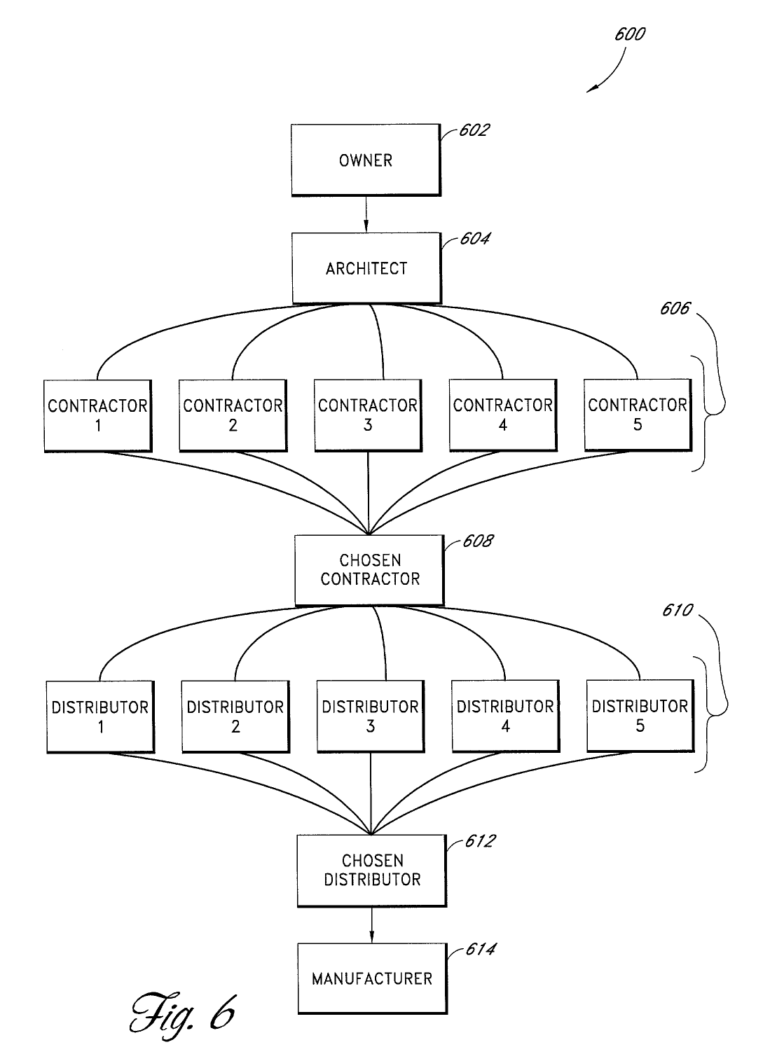

FIG. 6 illustrates an example bidding process 600 in accordance with the present invention. An owner 602 initially hires an architect 604 to design a project and develop architectural plans. The architectural plans include blueprints of the project and a list building materials necessary for the project. The architect utilizes the parts management system to enter and store the list of building materials, as well as a project description as previously described. The parts management system then encodes the manufacturer model part numbers of the building materials. The project description and the list of encoded model part numbers and the corresponding brief descriptions of the parts become part of the architectural plans. The list of encoded part numbers may also include the phrase “or equal” or the phrase “or equivalent,” indicating that an equal or equivalent part can be substituted if the specified part is no longer available from the manufacturer or supplier. Once the architectural plans are complete, the project goes out for bid. Several contractors 606 are chosen to bid on the project. The owner 602 then awards one of the contractors 608 the project. In turn, the selected contractor locates several part distributors 610 to bid on the project. The chosen contractor 608 then awards one of the distributors 612 the project. The chosen distributor 612, then finally locates a manufacturer 614 to supply the building materials listed on the plans.

The manufacturer utilizes the parts management system to decode the encoded model part numbers located on the architectural plans. A price quote is then generated by pricing the true manufacturer model part numbers, originally specified by the architect. Optionally, the parts management system rather than the manufacturer generates the price quote. The price management system accesses the manufactures price list or a copy of the manufacturer price list stored on the parts management system and generates a price quote listing the encoded part numbers and the associated prices. The price quote can then be provided to the manufacturer and/or the parts distributor. This optional approach advantageously prevents the manufacturer avoiding paying for use of the parts management system by not using the parts management system to accept an order.

Once the price quote is complete, the quote, listing the encoded part numbers and not the manufacturers part numbers, is given to the contractor via the parts distributor. If the manufacturer's quote is within the contractor's budget quoted earlier by the contractor to the owner, then the building materials are ordered. Otherwise, a rebidding process begins. By utilizing the parts management system and encoding the model part numbers, the contractor or the parts distributor have no choice but to order the same building materials or parts specified by the architect in the architectural plans.

Thus, as described above, the present invention provides a system and method for securely encoding and retrieving model part numbers. In doing so, the owner may manage the contractor and be assured that the architect specified building materials are the same building materials used to build the project.

Although this invention has been described in terms of certain preferred embodiments, other embodiments that are apparent to those of ordinary skill in the art are also within the scope of this invention.

What is claimed is:

1. A method of encoding and correlating data, the method comprising:
receiving project information from an architect over a network for storage on a parts management system;
storing the project information in a project information database;
receiving over the network a manufacturer model part number from the architect on the parts management system;
encoding the manufacturer model part number on the parts management system;
storing the encoded model part number in a project information database;
providing the encoded part number to a contractor who provides the encoded part number to a manufacturer via a manufacturer representative;
receiving over the network the encoded part number at the parts management system from the manufacturer;
decoding the encoded model part number provided by the manufacturer using the parts management system;
providing the decoded manufacturer model part number to the manufacturer; and
retrieving and providing the at least a part of the project information to the manufacturer.

2. The method as defined in claim 1, further comprising receiving an information type and a text message in association with the manufacturer model part number from the architect.

3. The method as defined in claim 1, further comprising providing a manufacturer name to the contractor in association with the encoded model part number.

4. The method as defined in claim 1, wherein the parts management system is accessed by the architect through a client application executing on a client computer system.

5. The method as defined in claim 1, wherein the parts management system is accessed by the architect via a web browser.

6. The method as defined in claim 1, wherein a project owner is provided only viewing access to the project information.

7. The method as defined in claim 1, further comprising the manufacturer utilizing the project information received from the parts management system to generate a price quote to present to the contractor.

8. A method of encoding by the parts management system, the method comprising:
receiving a project identifier and a manufacturer model part number at the parts management system;
encoding the project identifier into a plurality of alphanumeric characters to form an encoded project identification number;
encoding the manufacturer model part number into a plurality of alphanumeric characters to form an encoded manufacturer model number; and
generating the encoded model part number using the encoded project identification number and the encoded manufacturer model number.

9. The method as defined in claim 8, wherein the generating of the encoded model part number includes concatenating the encoded project identification number and the encoded manufacturer model number.

10. The method as defined in claim 8, wherein the generating of the encoded model part number further comprises generating a corresponding public key and private key.

11. A method of decrypting and correlating data, the method comprising:
receiving an encoded model part number from a contractor at a parts management system;
decoding the encoded model part number provided by the contractor on the parts management system; and
providing the decoded manufacturer model part number to the manufacturer by the parts management system.

12. The method as defined in claim 11, further comprising receiving a manufacturer name corresponding to the encoded model part number from the contractor.

13. The method as defined in claim 11, wherein decoding the encoded model part number includes mapping of the encoded model part number to the corresponding manufacturer model part number saved in a project information database.

14. The method as defined in claim 11, further comprising receiving from the architect a parts quantity in association with the encoded model part number.

15. The method as defined in claim 14, further comprising providing a price quote corresponding to the manufacturer model part number to the contractor.

16. The method as defined in claim 15, wherein the price quote is generated and transmitted electronically to at least one of a parts distributor and the contractor from the parts management system.

17. A method of bidding, the method comprising:
receiving project information for a project from a parts specifier for storage at a parts management system;
receiving a manufacturer model part number from the parts specifier at the parts management system;
encoding the manufacturer model part number on the parts management system;
returning the encoded model part number to the parts specifier;
creating an architectural plan corresponding to the project, the architectural plan including at least the encoded model part number;
choosing a plurality of contractors to bid on the project;
awarding a first of the contractors the project;
choosing a plurality of part distributors to bid to supply the part corresponding to the encoded model part number to the contractor;
selecting at least a first of the plurality of part distributors to supply the part for the project;
providing the encoded model part number from the contractor to the parts selected parts distributor;
decoding the encoded model part number on the parts management system;
transmitting the decoded model part number to the corresponding manufacturer; and
providing a price quote corresponding to the decoded manufacturer model part number to the contractor by the manufacturer.

18. The method as defined in claim 17, further comprising ordering building materials via the selected parts distributor from the manufacturer represented by the manufacturer model part numbers by the parts distributor.

19. The method as defined in claim 17, wherein decoding the encoded model part number includes mapping of the encoded model part number to the corresponding manufacturer model part number saved in a project information database.

20. The method as defined in claim 17, further comprising providing a manufacturer name to the contractor in association with the encoded model part number.

21. A method of encrypting and correlating data, the method comprising:
receiving a first part number from a first user on a parts management system;
encoding the first part number on the parts management system to create a second part number;
storing the first and second part numbers in an information database;
providing the second part number to a second user who provides the second part number to a third user via a representative;
receiving the second part number at the parts management system from the third user;
decoding the second part number provided by the third user on the parts management system to receive the first part number; and
providing the first part number to the third user.

22. The method as defined in claim 21, wherein the first user is one of an architect, a parts specifier, and a project owner.

23. The method as defined in claim 21, wherein the second user is a contractor.

24. The method as defined in claim 21, wherein the third user is a manufacturer.

25. The method as defined in claim 21, wherein the first part number is a manufacturer model part number.

26. The method as defined in claim 21, further comprising receiving a manufacturer name associated with the first part number.

27. The method as defined in claim 21, further comprising receiving a project identifier, wherein the second part number contains project identifier information.

28. A method of encoding and correlating data, the method comprising:
receiving a first part number from a first user on a parts management system;
encoding the first part number on the parts management system to create a second part number;
receiving a first manufacturer name associated with the first part number;
storing the first part number, the second part number, and the first manufacturer name in an information database;
receiving a third part number associated with a second manufacturer from a first user on a parts management system;
encoding the third part number on the parts management system to create a fourth part number;
receiving a second manufacturer name associated with the third part number;
storing the third part number, the fourth part number, and the second manufacturer name in the information database;
providing the second part number, the fourth part number, and the first and second manufacturer names to a second user, wherein the second user is intended to provide the second and fourth part numbers to a third user;
receiving the second and fourth part numbers at the parts management system from the third user;
decoding the second and fourth part numbers provided by the third user on the parts management system to reproduce the first and third part numbers; and
providing the first and third part numbers to the third user.

29. The method as defined in claim 28, wherein the first user is one of an architect, a parts specifier, and a project owner.

30. The method as defined in claim 28, wherein the second user is a contractor.

31. The method as defined in claim 28, wherein the third user is a manufacturer.

32. The method as defined in claim 28, wherein the first and third part numbers are a manufacturer model part number.

33. A system for utilizing a parts management system, the system comprising:
a first instruction configured to receive a manufacturer part number from a first user;
a second instruction configured to receive a project identifier;
a third instruction configured to encode the manufacturer model part number provided by the first user based on the manufacturer model part number and the project identifier to form an encoded model part number;
a fourth instruction configured to save the manufacturer model part number and the associated encoded model number to a project information database;
a fifth instruction configured to receive the encoded model part number from a second user;
a sixth instruction configured to decode the encoded model part number received by the second user by mapping to the encoded model part number to the corresponding manufacturer model part number; and
a seventh instruction configured to provide the manufacturer model part number to the second user.

34. The system defined in claim 33, wherein the first user is at least one of an architect, a parts specifier, and a project owner.

35. The system defined in claim 33, wherein the second user is a manufacturer.

36. The system defined in claim 33, further comprising an eighth instruction configured to receive project information, including at least the architect's and a manufacturer representative's contact information.

37. A system for utilizing a parts management system, the system comprising:
a first instruction configured to receive project information, a manufacturer model part number, and a manufacturer name corresponding to the manufacturer model part number provided by a first user;
a second instruction configured to encode the manufacturer model part number to form an encoded model part number;
a third instruction configured to save the manufacturer model part number, the corresponding encoded model number, the manufacturer name corresponding to the manufacturer model part number, and the project information to a project information database;
a fourth instruction configured to receive at least one of the encoded model part number and the manufacturer name from a second user;
a fifth instruction configured to decode the encoded model part number received from the second user by mapping to the corresponding manufacturer model part number; and
a sixth instruction configured to provide the manufacturer model part number and the project information to a third user.

38. The system defined in claim 37, wherein the first user is at least one of an architect, a parts specifier, and a project owner.

39. The system defined in claim 37, wherein the second user is a manufacturer.

40. The system defined in claim 37, wherein the third user is a manufacturer.

41. The system defined in claim 37, wherein the project information includes at least the architect's and a representative's contact information.
